(19) United States
(12) Patent Application Publication
(10) Pub. No.: US 2019/0031438 A1
(43) Pub. Date: Jan. 31, 2019

(54) Multi-Layered Nesting Trash Bag

(71) Applicants: Paul Zipperlen, Keller, TX (US); Ryan Mike-Mayer, Grapevine, TX (US)

(72) Inventors: Paul Zipperlen, Keller, TX (US); Ryan Mike-Mayer, Grapevine, TX (US)

(21) Appl. No.: 16/043,701

(22) Filed: Jul. 24, 2018

Related U.S. Application Data
(60) Provisional application No. 62/536,842, filed on Jul. 25, 2017.

(51) Int. Cl. B65F 1/06; B65F 1/00

(52) U.S. Cl. CPC B65F 1/067; B65F 1/0006; B65F 2250/114; B65F 2210/138; B65F 2220/12; B65F 1/068

(57) ABSTRACT

A system and method for nesting multi-layered trash bags for trash receptacles. The bags preferably each have an elastic member providing compression to securely hold the nested trash bags in relative position until filled and removed. The elastic member is a rubber element or alternatively an elastic drawstring. A rigid member can be utilized in conjunction with the nested trash bags to facilitate the installation of the multi-layered trash bags into the trash can.

### CROSS REFERENCE TO RELATED APPLICATIONS

This application claims the benefit of U.S. Application No. 62/536,842, filed 25 Jul. 2017, titled “MULTI-LAYERED NESTING TRASH BAGS,” all of which is hereby incorporated by reference for all purposes as if fully set forth herein.

### BACKGROUND

### 1. Field of the Invention

The present invention relates in general to the field of trash bags and nesting them neatly and conveniently in use with a conventional trash can. The apparatus utilizes multiple liners within a complementary container, wherein a user is able to remove the most exposed liner filled with rubbish and subsequently reveal an additional liner.

### 2. Description of Related Art

Trash cans utilize plastic liners to store and contain rubbish. Typically a liner is installed into a trash can and replaced when the liner is full. The trash receptacle cannot be fully used until another liner is installed. Furthermore, because of the time and energy to install a new liner after removing the old one users wait to remove liners until after they are near or beyond capacity. While there are many ways to install trash bags into the trash can known in the art, considerable room for improvement remains.

### DESCRIPTION OF THE DRAWINGS

The novel features believed a characteristic of the embodiments of the present application is set forth in the appended claims. However, the embodiments themselves, as well as a preferred mode of use, and further objectives and advantages thereof will best be understood by reference to the following detailed description when read in conjunction with the accompanying drawings, wherein:

FIG. 1 is a plan view of a multi-layered nested set of trash bags according to the present application;

FIG. 2 is a plan view of a multi-layered nested set of trash bags in a conventional trash receptacle according to the present application;

FIG. 3 is a plan view of a multi-layered nested set of trash bags in a conventional trash receptacle according to the present application;

FIG. 4 is a plan view of a multi-layered nested set of trash bags on a holder according to the present application;

FIG. 5 is a plan view of a holder for a multi-layered nested set of trash bags according to the present application;

FIG. 6 is a plan view of a holder for a multi-layered nested set of trash bags in a trash receptacle according to the present application;

FIG. 7A is a partial plan view of a multi-layered nested set of trash bags according to the present application;

FIG. 7B is a section view of a multi-layered nested set of trash bags according to the present application; and

FIG. 8 is a plan view of a multi-layered set of trash bags unnested according to the present application.

While the assembly and method of the present application are susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of multi-layered nesting trash bags are provided below. It will, of course, be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system described herein allows for users to have a clean and fresh trash can daily. Odors are reduced or eliminated since rubbish is removed more timely because of the ease of the system and method. Trash cans will be less filled with the ease of removing the liner to expose another liner precludes the need to overstuff trash bags in trash cans. The system and method herein are suitable for various sized trash cans, medical waste containers, used diaper systems, pedicure bowls, and wash stations, basically any situation where a new plastic lined product is required.

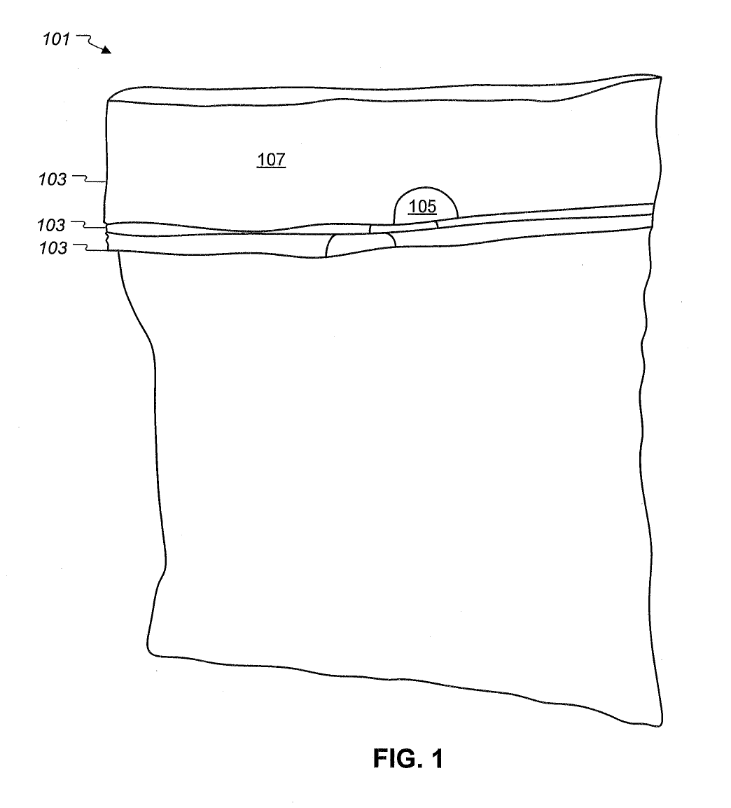

Referring to FIG. 1 in the drawings, a multi-layered nesting trash bag system. System 101 is comprised of a plurality of trash bags 103. Each trash bag 103 is comprised of a first and a second layer of plastic sealed, typically with heat, along three sides to form the trash bag. Other sealing methods are contemplated by this application. Furthermore, each trash bag 103 further comprises a closing member 105. Closing member 105 in this embodiment is a drawstring, or equivalent, the drawstring located in a channel adjacent an opening of the trash bag. Alternatively the drawstring is directly attached to the trash bag. The channel has at least one opening where the user can grab the drawstring and cinch the opening of the bag. In the preferred embodiment, the drawstring can cinch the bag closed and grip the side of the trash can or container the bag is stored in. Alternatively the drawstring only grips the side of the trash can and does not provide a closure for the trash bag.

Starting with the most inner trash bag of the plurality each additional bag is located exterior to the most inner trash bag. Once the plurality of trash bags 103 are nested, the edges of the bags are folded over to form a ring 107. This ring 107 can be installed around a lip of a container, such as a trash can, and a lined container formed. As the inner most trash bag is filled with rubbish the user one-handedly grasps the drawstring and removes the trash bag exposing the next most inner trash bag until all the trash bags of the plurality have been filled and removed.

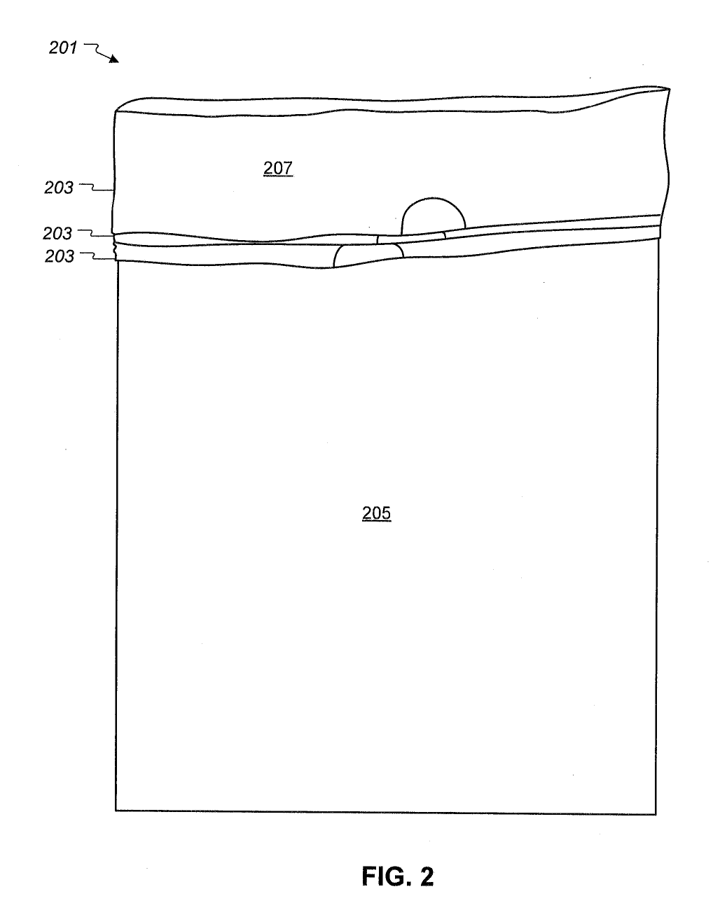

Referring now also to FIG. 2 in the drawings, a multi-layered nesting trash bag system located in a trash can. System 201 is comprised of a plurality of trash bags 203 located in trash can 205. Each trash bag 203 is comprised of a first and a second layer of plastic seamed along three sides to form the trash bag. In an alternative embodiment the bag may be comprised of more or less edges. For example, a bag can be made in the shape of a triangle seamed on two sides with one side left open to access the interior of the trash bag.

Starting with the most inner trash bag of the plurality each additional bag is located exterior to the most inner trash bag. Once the plurality of trash bags 203 are nested, the edges of the bags are folded over to form a ring 207. This ring 207 can be installed around a lip of a container, such as a trash can 205, and a lined container formed. As the inner most trash bag is filled with rubbish the user grasps the drawstring and removes the trash bag exposing the next most inner trash bag until all the trash bags of the plurality have been filled and removed. Additionally, an adhesive tab may be located at the bottom of the nested liners and couples the trash can to the last trash bag of the plurality of trash bags 203.

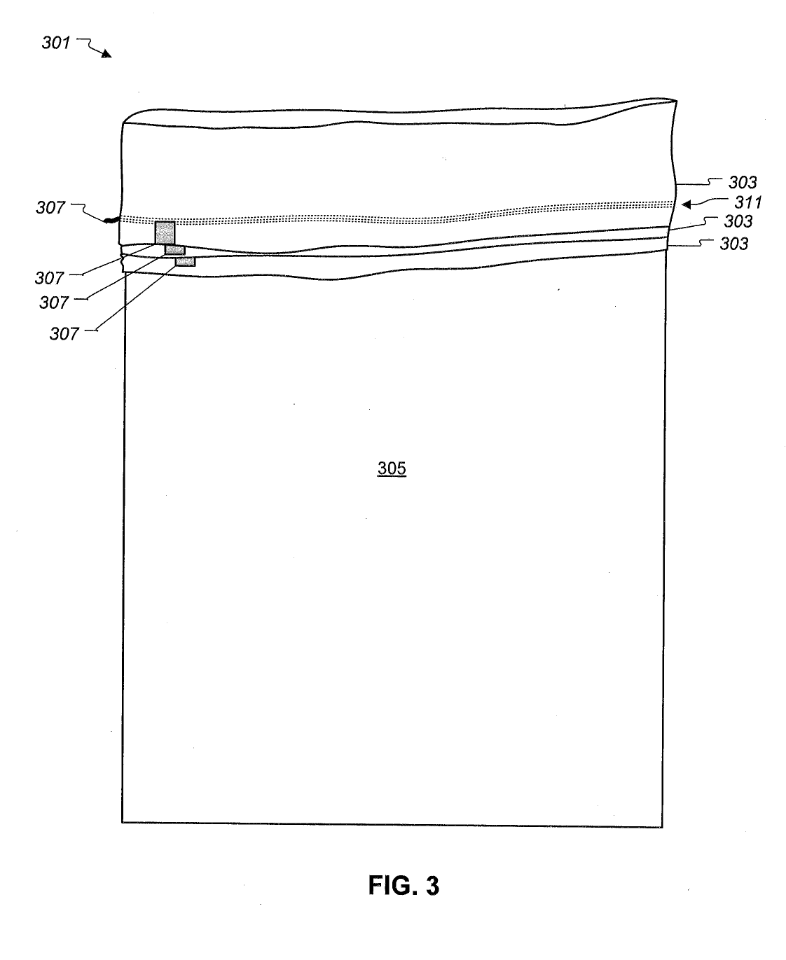

Referring now also to FIG. 3 in the drawings, a multi-layered nesting trash bag system located in a trash can. System 301 is comprised of a plurality of trash bags 303 located in trash can 305. Each trash bag 303 is comprised of a first and a second layer of plastic seamed along three sides to form the trash bag. Furthermore, trash bag 303 is further comprised of a first tab 307, a second tab 309, and an elastic member 311. First tab 307 is a member having an end connected to the bag adjacent the elastic member 311. The user grabs the first tab 307 and can pull elastic member and the connected bag away from rest of the nested bags and the trash can 305. First tab 307 is preferably an additional piece to the bag, however, it is contemplated that the tab is formed of the bag and integral with the bag. Second tab 309 is a portion of the elastic member 311 that protrudes from the bag to enable a user to apply force directly to the elastic member 311. In this embodiment, the elastic member is a portion of the trash bag treated to have more elastic properties such as by heating. Alternatively, the elastic member 311 is a rubber band in a closed compartment. As the inner most trash bag is filled with rubbish the user grasps the first tab 307 or second tab 309 and removes the trash bag exposing the next most inner trash bag until all the trash bags of the plurality have been filled and removed. While the elastic member is preferably as large as the opening of the trash bag, a partial elastic element spanning a portion of the opening is contemplated.

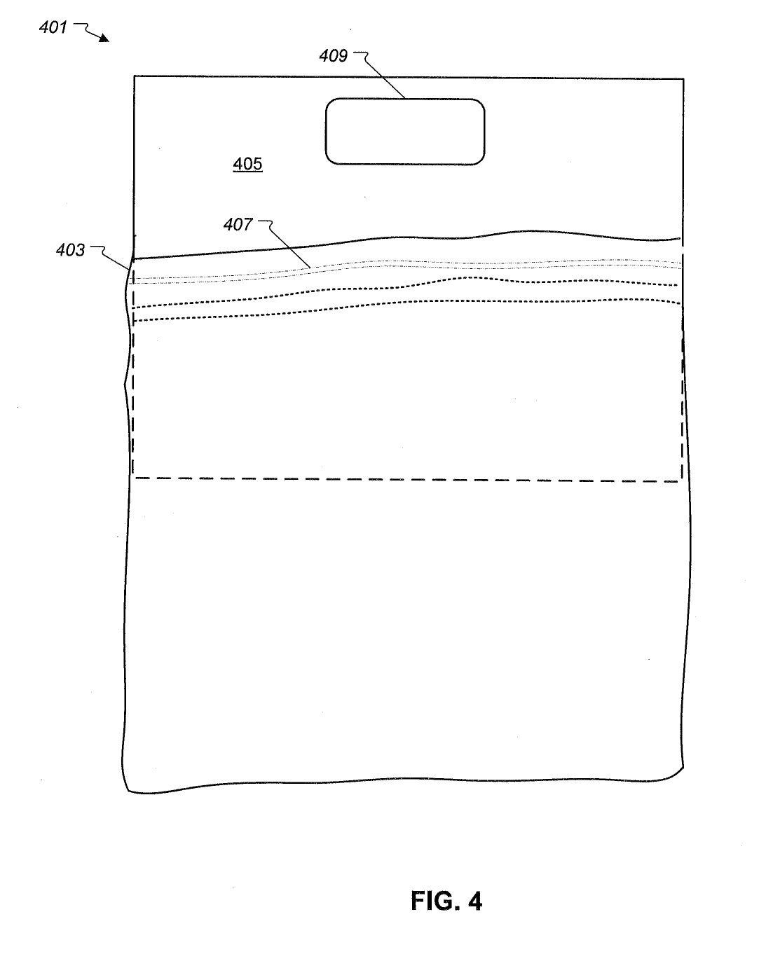

Referring now also to FIG. 4 in the drawings, a multi-layered nesting trash bag system. System 401 is comprised of a plurality of trash bags 403 located on a rigid member 405 or semi-rigid member. Each trash bag 403 is comprised of a first and a second layer of plastic seamed along three sides to form the trash bag. Furthermore, each trash bag 403 further comprises a closing member 407 which provides compression against the rigid member 405. Closing member 407 in this embodiment is a rubber band located in a channel adjacent an opening of the trash bag. Rigid member 405 is preferably a rectangular cardboard member with a handle 409. Member 405 is contemplated as having other shapes. The user is able to use the handle to assist installing the nested trash bags into a trash can. In an alternative embodiment, there are two layers of cardboard to form the rigid member 405 that split to create an opening similar to the interior of the trash can between the two layers.

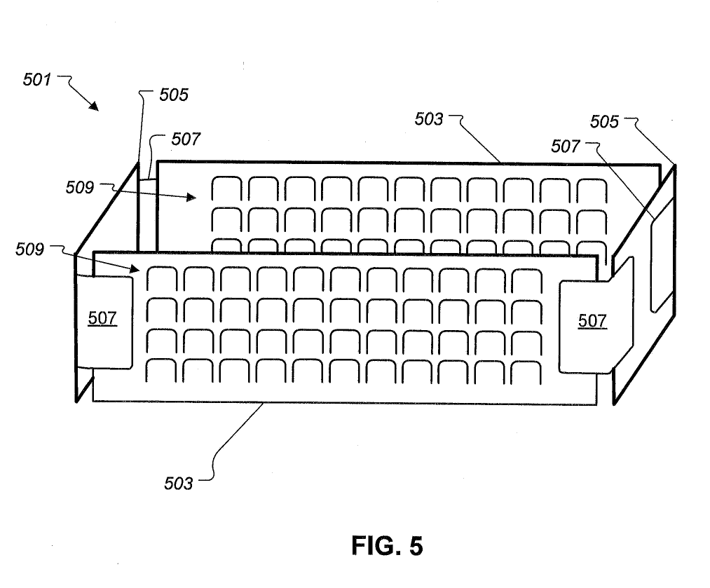

Referring now also to FIG. 5 in the drawings, a holder for a multi-layered nesting trash bag system. Holder 501 is comprised of a first pair of tabbed members 503 and a second pair of members 505 coupled together by elastic members 507 to form the rectangular holder. Tabbed members 503 is comprised of an arrayed series of tabs 509 spaced vertically and horizontally, each tab configured to retain a portion of the associated trash bag. Each row of tabs is aligned to receive a portion of the trash bag. In the preferred embodiment, each row of tabs is utilized for a single trash bag. For example, as shown in FIG. 5 four separate trash bags could be nested because four rows of tabs exist. Alternative embodiments feature more or fewer rows of tabs, for example, seven and thirty rows of tabs are contemplated by this application. For example, a multiple say system, a weekly system, and a monthly system. Furthermore, a trash can having several months of nested trash bags is contemplated by this application. Additionally, the second pair of members 505 may be tabbed to assist holding the nested trash bags.

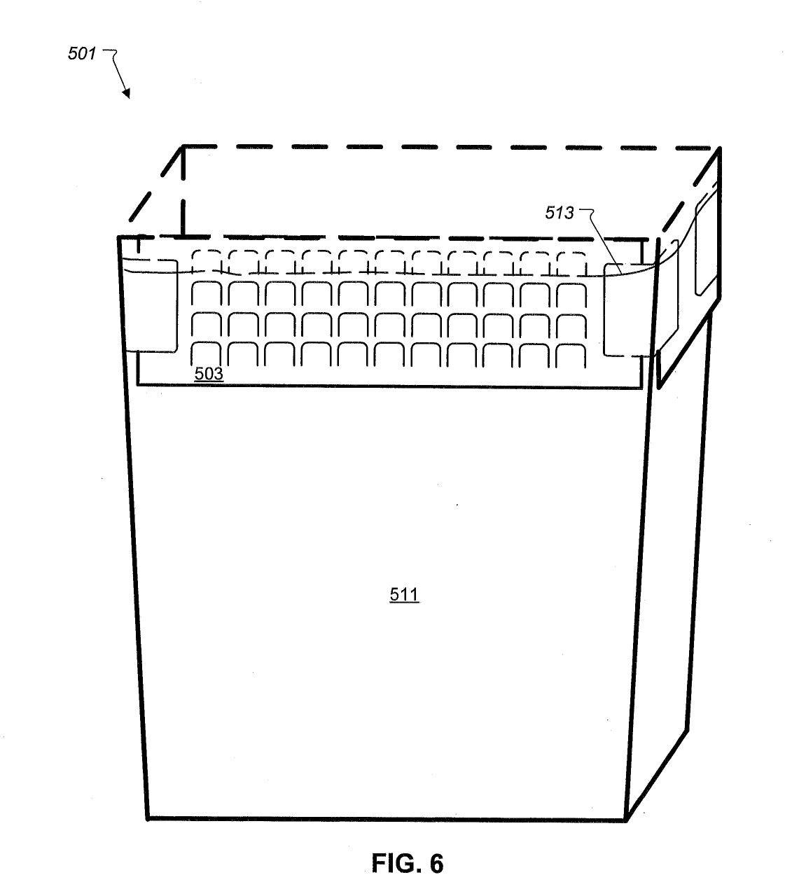

Referring now also to FIG. 6 in the drawings, a holder for a multi-layered nesting trash bag system in a trash receptacle. Holder 501 is coupled to a trash can 511 and is retaining a single trash bag 513. The single trash bag 513 is located in the highest row of tabs because it is the last nested bag.

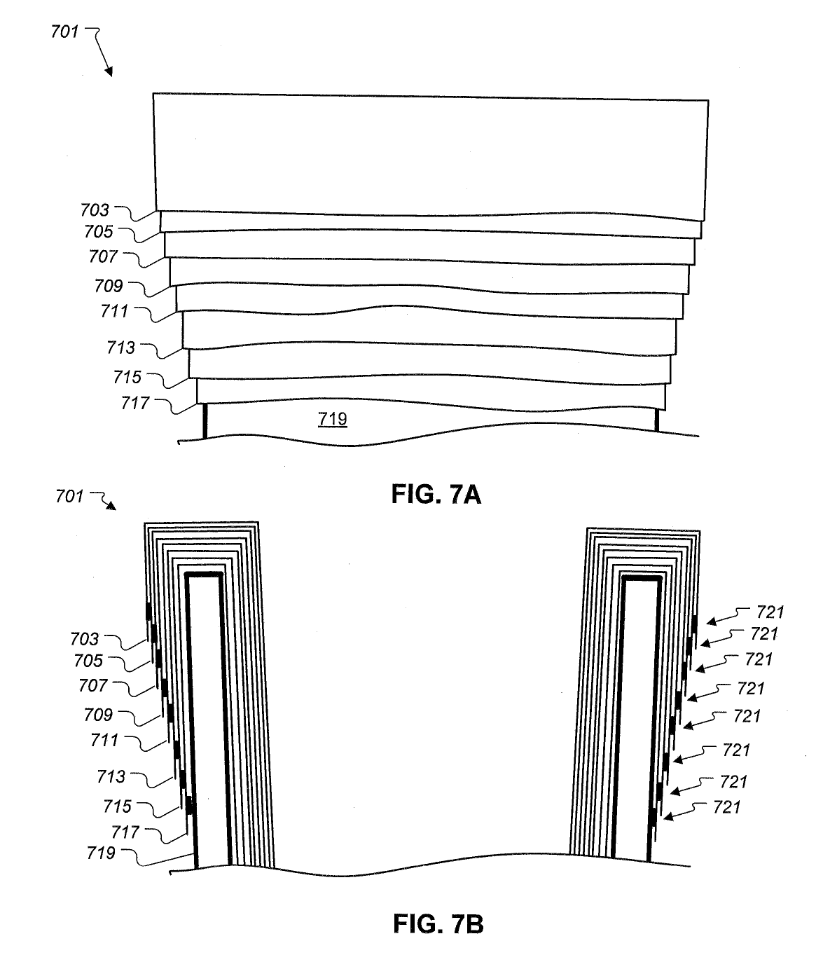

Referring now also to FIGS. 7A and 7B in the drawings, a multi-layered nesting trash bag system. System 701 is comprised of a first trash bag 703, a second trash bag 705, a third trash bag 707, a fourth trash bag 709, a fifth trash bag 711, a sixth trash bag 713, a seventh trash bag 715, an eighth trash bag 717, and a trash can 719. The first trash bag 703 is the outer most and most readily accessible. Once the first trash bag 703 is filled with trash the user would remove the first trash bag and expose the second trash bag 705 for use. The method would continue until the eighth trash bag 717 is used and removed leaving only the trash can remaining. The user then can install another set of nested trash bag and repeat the process. Located around a periphery of each of the trash bags is an elastic element to provide compression to keep the bags in place until the user removes the full bag. Furthermore, the air between each of the bags is minimalized and or removed. Additionally, air movement from between the bag and the can is minimized because each elastic element acts to seal air movement from within the nested system of bags. In this embodiment, the elastic element is a rubber band 721.

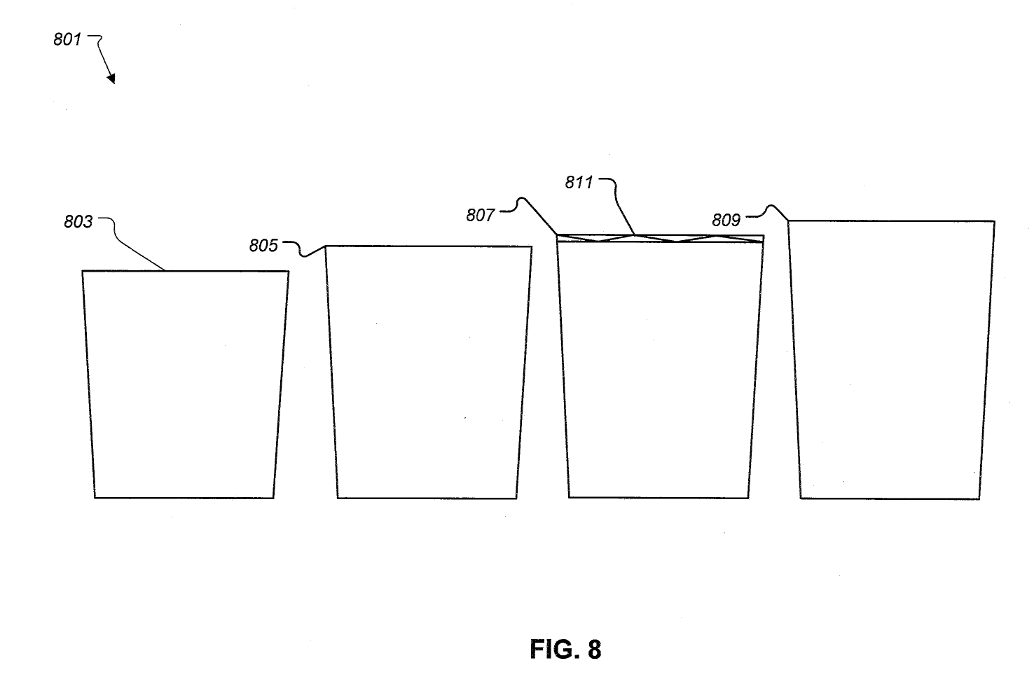

Referring now also to FIG. 8 in the drawings, a multi-layered nesting trash bag system. System 801 is comprised of a first trash bag 803, a second trash bag 805, a third trash bag 807, and a fourth trash bag 809. The first trash bag 803 is the smallest bag of the system 801. The fourth trash bag 809 is the largest bag of the system 801. Each bag has a slightly different size so that when they are nested together they fit as the first bag 803 fits inside the second bag 805. Additionally, the second bag fits inside the third bag 807 and the third bag 807 then fits inside the fourth bag 809. Alternatively, each bag is the same size in height and width. The third bag comprises a mark 811 to alert the user that the user has only two bags remaining. Alternatively, each bag is labeled to give a countdown of the number of remaining nested bags.

It is apparent that a system and method with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments but are amenable to various changes and modifications without departing from the spirit thereof.

1. A nested system of trash bags, comprising:
a plurality of trash bags;
wherein the plurality of trash bags are nested.

2. The nested system of trash bags according to claim 1, wherein each of the plurality of trash bags is comprised of a folded lip having a closing member.

3. The nested system of trash bags according to claim 2, further comprising:
a trash can;
wherein the folded lip of each of the plurality of trash bags extend over an edge of the trash can.

4. The nested system of trash bags according to claim 1, wherein each of the plurality of trash bags is comprised of:
a folded lip;
an elastic strap; and
a tab protruding from the folded lip.

5. The nested system of trash bags according to claim 1, further comprising:
a rigid member.

6. The nested system of trash bags according to claim 5, wherein each of the plurality of trash bags is comprised of:
a folded lip; and
an elastic strap.

7. The nested system of trash bags according to claim 6, wherein each of the plurality of trash bags is further comprised of:
a tab protruding from the folded lip.

8. The nested system of trash bags according to claim 1, further comprising:
a holder having;
a plurality of tabs arranged into rows;
wherein a lip of each of the plurality of trash bags are retained by a row of tabs.

9. A nested system of trash bags, comprising:
a trash can;
a first trash bag elastically coupled to the trash can; and
a second trash bag elastically coupled to the trash can over the first trash bag;
wherein an amount of air between the first trash bag and the second trash bag is minimized.

10. A nested system of trash bags, comprising:
a first trash bag having a first size; and
a second trash bag having a second size nested over the first trash bag;
wherein the second size is larger than the first size.

11. The nested system of trash bags according to claim 10, further comprising:
a third trash bag having a third size nested over the second trash bag;
wherein the third size is larger than the second size.

12. The nested system of trash bags according to claim 11, further comprising:
a fourth trash bag having a fourth size nested over the third trash bag;
wherein the fourth size is larger than the third size.

13. The nested system of trash bags according to claim 10, further comprising:
a mark located on the second trash bag configured to alert a user to only two trash bags remaining.
